(19) United States
(12) Patent Application Publication
(10) Pub. No.: US 2005/0075916 A1
(43) Pub. Date: Apr. 7, 2005

(54) Integrated governance

(76) Inventors: Charles J. Lathram, Duluth, GA (US); Allen Nelson, Atlanta, GA (US); Connie Q. Veates, Atlanta, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/802,370

(22) Filed: Mar. 17, 2004

Related U.S. Application Data
(60) Provisional application No. 60/508,629, filed on Oct. 2, 2003.

(51) Int. Cl. G06F 17/60

(52) U.S. Cl. 705/7

(57) ABSTRACT

The present disclosure provides systems and methods for implementing the Integrated Governance program. Briefly described, some embodiments of a method comprise the steps of: forming an Integrated Governance team to identify problematic issues in designated governance areas across a business enterprise, the Integrated Governance team comprising members having knowledge of designated governance areas and of operational units within the enterprise; compiling data from a plurality of databases that contain information regarding the governance areas for a plurality of the operational units in the enterprise; integrating together data from the plurality of databases to form a comprehensive summary of governance information for the enterprise; analyzing, as a team, the comprehensive summary to identify one or more significant issues within the governance areas for the enterprise; and forming a plan to address a respective issue (e.g., developing business controls where there is no clear owner of an issue, etc.).

### CROSS-REFERENCE TO RELATED APPLICATION

This application claims priority to U.S. provisional application entitled, “Integrated Governance Process,” having ser. No. 60/508,629, filed Oct. 3, 2003, which is entirely incorporated herein by reference.

### TECHNICAL FIELD

The present disclosure is generally related to business management and, more particularly, is related to management oversight.

### BACKGROUND

Companies are governed by an assortment of regulations, laws, voluntary codes, industry codes, and corporate policies. Accordingly, many companies set up governance programs to monitor and facilitate company adherence to legal regulations and company policies. However, current governance programs for identifying and mitigating risk issues across a company are often ineffective as is evidenced by recent corporate scandals and new federal regulations regarding corporate compliance and governance. Thus, a heretofore unaddressed need exists in the industry to address the aforementioned deficiencies and inadequacies.

### SUMMARY

Embodiments of the present disclosure provide a system and method for implementing an Integrated Governance program within a business organization or enterprise. Briefly described, in architecture, some embodiments of such a system provide a plurality of governance sources monitoring respective governance areas within the business enterprise. A plurality of governance databases is maintained by respective governance sources. The plurality of governance databases is interconnnected by at least one or more communication networks. Accordingly, via the governance databases, an integrated governance team reviews data to identify significant issues for the enterprise in the governance areas.

Some embodiments, among others, of a method for implementing the Integrated Governance program comprise the steps of: forming an Integrated Governance team to identify problematic issues in designated governance areas across a business enterprise, the Integrated Governance team comprising members having knowledge of each of the designated governance areas and of operational units within the enterprise; compiling data from a plurality of databases that contain information regarding the governance areas for a plurality of the operational units in the enterprise; integrating together data from the plurality of databases to form a comprehensive summary of governance information for the enterprise; analyzing, as a team, the comprehensive summary to identify one or more significant issues within the governance areas for the enterprise; and utilizing collective knowledge of the Integrated Governance team to uncover the fundamental cause of the respective significant issue; and forming, as a team, a comprehensive plan to address the fundamental cause of the respective significant issue across the business enterprise (e.g., developing appropriate business controls where there is no clear owner of an issue, etc.).

Other features, and advantages will be or become apparent to one with skill in the art upon examination of the following drawings and detailed description. It is intended that all such additional systems, methods, features, and advantages be included within this description.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of an Integrated Governance system for implementing an Integrated Governance program within a business organization 202.

FIG. 2 is a diagram of one embodiment of an organizational structure that serves to facilitate the implementation of the Integrated Governance program of FIG. 1.

FIG. 3 is a diagram showing a sample list of core compliance areas utilized in the Integrated Governance program of FIG. 1.

FIG. 4 is a flowchart describing one embodiment of a unified process for determining business control levels for the Integrated Governance program of FIG. 1.

FIG. 5 is a diagram showing one embodiment of a risk assessment matrix utilized in the unified process of FIG. 4.

FIG. 6 is a diagram showing one embodiment of a summary of risk assessment for business units for the Integrated Governance program of FIG. 1.

FIG. 7 is a diagram showing an organization-wide view of business control levels for the Integrated Governance program of FIG. 1.

FIG. 8 is a diagram showing one embodiment of portion of a status report of compliance activities for the Integrated Governance program of FIG. 1.

FIG. 9 is a screenshot of a sample ethics record from a database in the system of FIG. 1.

FIG. 10 is a screenshot of a sample ethics record from a database in the system of FIG. 1.

FIG. 11 is a screenshot of a sample Ethics and Comopliance website in the system of FIG. 1.

FIG. 12 is a screenshot of a sample audit report from a database in the system of FIG. 1.

FIG. 13 is a screenshot of a sample audit report from a database in the system of FIG. 1.

FIG. 14 is a screenshot of a sample security case management document from a database in the system of FIG. 1.

FIG. 15 is a screenshot of a sample security case management document from a database in the system of FIG. 1.

FIG. 16 is a screenshot of a sample database management program accessing a database maintained by a business controls group of FIG. 1.

FIG. 17 is a screenshot of a sample database management program accessing a database maintained by a business controls group of FIG. 16.

FIG. 18 is a flowchart describing one embodiment of an Integrated Governance process for completing Integrated Governance activities within the Integrated Governance program of FIG. 1.

FIG. 19 is a diagram of a sample common template for compiling data from the databases of FIG. 1.

FIG. 20 is a flowchart of one embodiment of a common analytical process utilized in the Integrated Governance program of FIG. 1.

FIG. 21 is a diagram showing a sample documentation of a root cause analysis utilized in the Integrated Governance program of FIG. 1.

FIG. 22 is a diagram showing a sample quarterly tracking report detailing outstanding issues that are being monitored within the Integrated Governance program of FIG. 1.

FIG. 23 is a diagram showing a sample report of results from an example training exercise utilized within the Integrated Governance program of FIG. 1.

FIG. 24 is a flowchart describing one embodiment of an Integrated Governance process of FIG. 18 in terms of performed activities and owners of these activities.

### DETAILED DESCRIPTION

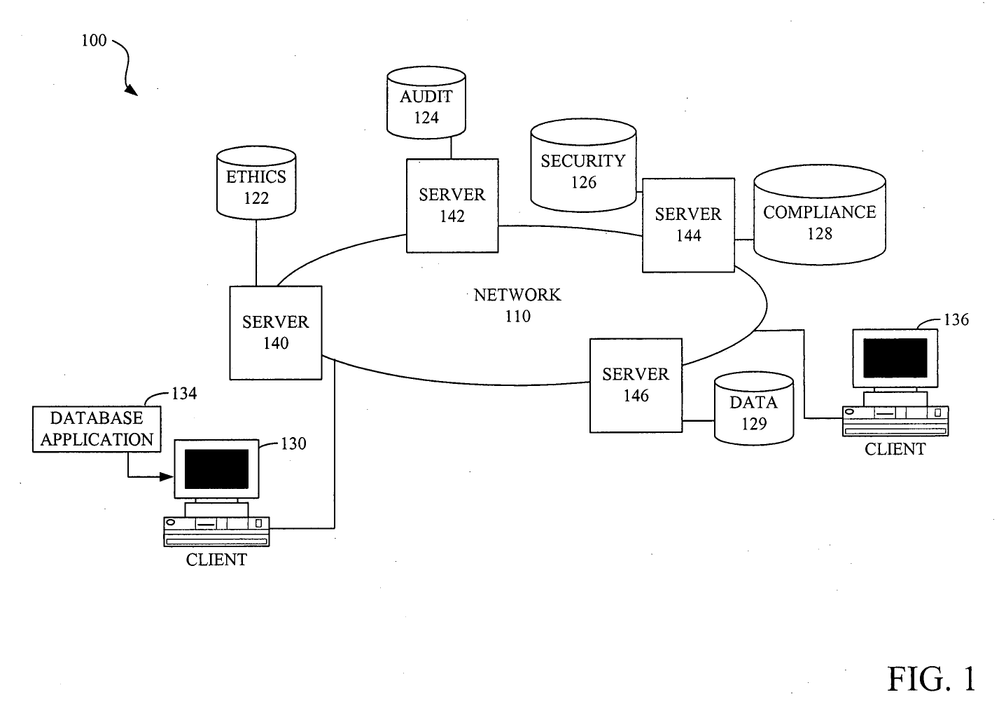

FIG. 1 is a block diagram of one embodiment 100 of an Integrated Governance system for implementing an Integrated Governance program within a business organization 202 or enterprise. The Integrated Governance system 100 includes a business network 110 (e.g., an enterprise network) and a plurality of databases 122-129 connected to the business network 110. Typically, different departments within a business organization 202 utilize different databases 122-129 to store their respective work products, such as reports, records, memoranda, etc. A plurality of client systems 130, 136 are also connected to the business network 110. In one embodiment, a client system 130 is a computer including a database application 134 for accessing one of the plurality of databases 122-129, such as a data management program (e.g., Lotus 1-2-3®, Lotus Notes®, Open Database Connectivity (ODBC) compliant applications, etc.). A plurality of servers 140-146 is connected to the business network 110 and access the plurality of databases 122-129. In one embodiment, the plurality of servers 140-146 is configured with a database management system to enable a respective server to store, modify, and extract information from the databases 122-129. The associated databases 122-129 further include associated database documents which can be accessed and updated by authorized users, through the database application 134 at one of client systems 130, 136 by logging onto an associated server 140-146.

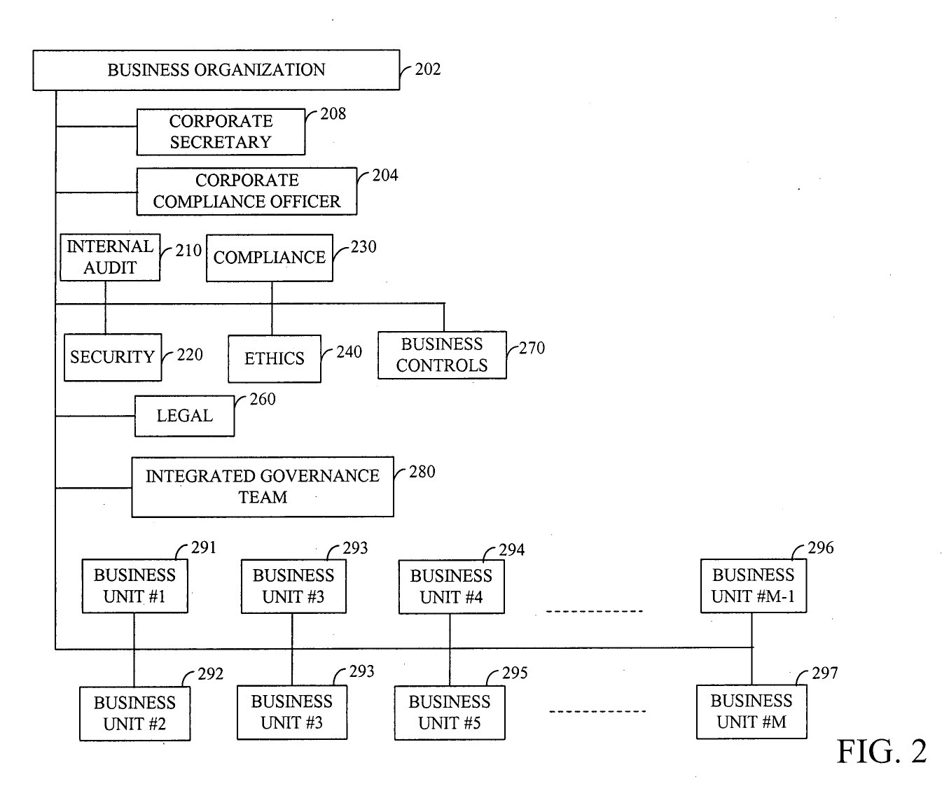

By pulling together data from across various organizational departments (via the Integrated Governance program), emerging business trends, and problems can be proactively identified before becoming a material or significant issue. Accordingly, solutions for these issues and problems can be developed quickly. An organizational structure 200 shown in FIG. 2 serves to facilitate the implementation of an Integrated Governance program for a business organization 202. Here, a plurality of governance departments for performing certain governance activities is designated for a business organization 202, such as a corporation. In FIG. 2, the governance departments include an Internal Audit group 210, a Security group 220, a Compliance group 230, an Ethics group 240, and a Business Controls group 270. Each governance group reports to a managing oversight department or company officer(s), such as a Corporate Compliance Officer 204 and/or Corporate Secretary 208. These organizational groups 204-260 are charged with perform monitoring functions for the organization 202, such as detecting existing problems or researching problems that are brought to their attention by people outside of their group or departmental areas. A Legal Department 260 is also provided to work with each of the groups and any issues that they encounter.

The various governance groups 210-270 work together to ensure that the operational business units 291-297 are in compliance with external regulations and internal policies of the business organization 202. For example, the Compliance group 230 helps set and implement corporate policies regarding compliance activities. Other governance groups, such as Internal Audit 210, Security 220, and Ethics 240, then monitor the business units 291-297 to assure that the business units are complying with these corporate policies (regarding compliance activities). Further, a Business Controls group 270 implements control measures (and assigns responsibility for these control measures) to enable the business units 291-297 to comply with external regulations and internal policies.

In particular, the operational business units 291-297 perform the day-to-day business operations and functions for the business organization 202, where a particular business unit performs a particular role or operation for the organization 202. For example, the various operational business units 291-297 may include Advertising & Publishing, Corporate Technology, Finance, Human Resources, Network, etc. Each business unit 291-297 may also maintain their own database 129 of information (within the Integrated Governance system of FIG. 1) related to the business unit.

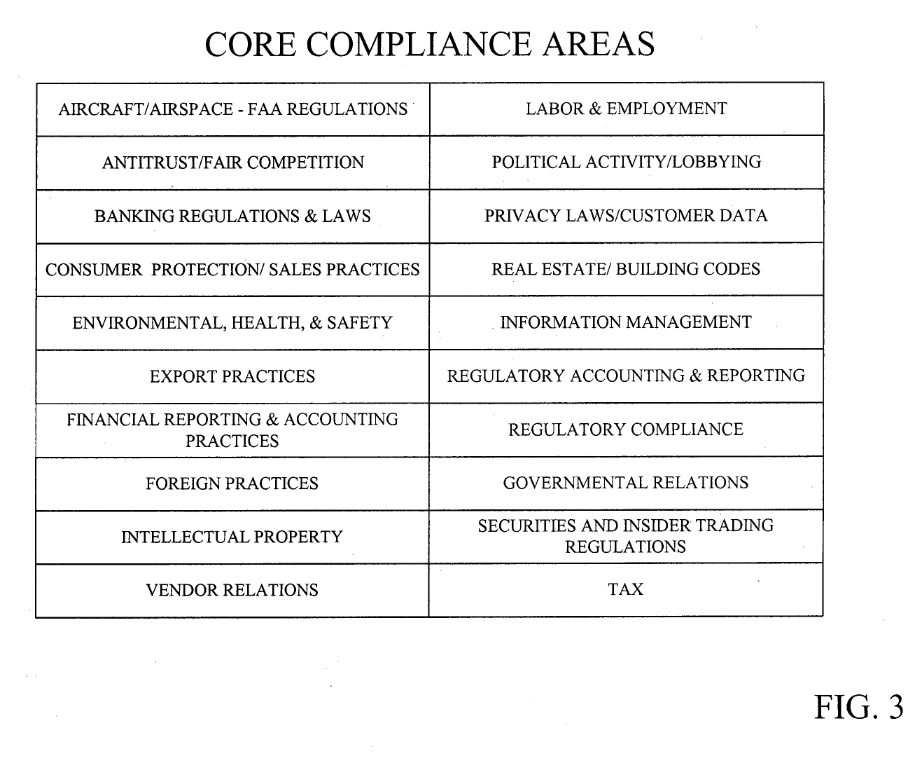

Referring back to the various governance groups for one embodiment, the Compliance group 230 has a reporting structure that starts with its board of directors and includes an active Compliance Policy Board. The Compliance Policy Board evaluates, reviews, and enhances company policy and standards. In particular, the Compliance Policy Board performs an integrity function to ensure that the company creates policies that are in alignment with other policies across the organization 202. The Compliance Policy Board also evaluates ethics and integrity issues and anticipates trends in company ethics; conducts reviews of the effectiveness of compliance activity in the operational business units 291-297; and reviews discipline policy to ensure consistent enforcement of organizational standards. Additionally, the Compliance group 230 contains integral members of the operational business units 291-297. The integral members of the business units help ensure that all compliance activities flow through the business units 291-297. For example, a “Compliance Senior Leader” is ultimately responsible for ensuring that the business units' business control processes are in place and will help ensure that the business unit is in compliance with applicable laws and regulations and with organizational standards and policies. A “Compliance Coordinator” performs periodic reviews of the inventory and risk assessment; implements and monitors the yearly action plan and associated reports; and makes periodic reports to the Compliance Policy Board. Further, “Subject Matter Experts” are typically lawyers or operational experts who provide advice and guidance around defined core areas of compliance in the company. A sample list of core compliance areas for one embodiment is shown in FIG. 3.

The Business Controls group 270 is typically provided to address risk management and business control issues within the organization 202. In particular, the Business Controls group 270 serves as a consultative group to the operational business divisions (or units) 291-297 within the company. At the units' request, the Business Controls group 270 assesses risks of operational business processes and define business control needs. The Business Controls group then works hand-in-hand with business units 291-297 to develop adequate business controls to mitigate the risks present in these processes. With a separate Business Controls group 270, the separate and objective perspective of Internal Auditing 210 is maintained, while the Business Controls group 270 can work throughout the year with the business units 291-297.

In some embodiments, the Business Control group 270 also conducts forensic data analysis, among other activities, to test data integrity across the business organization 202 and to identify problems that are not evident at the process level. For example, business units 291-297 can request data analysis as the units 291-297 are releasing new products or processes. Data analysis can also be done from an organizational perspective to ensure that existing business processes are working correctly.

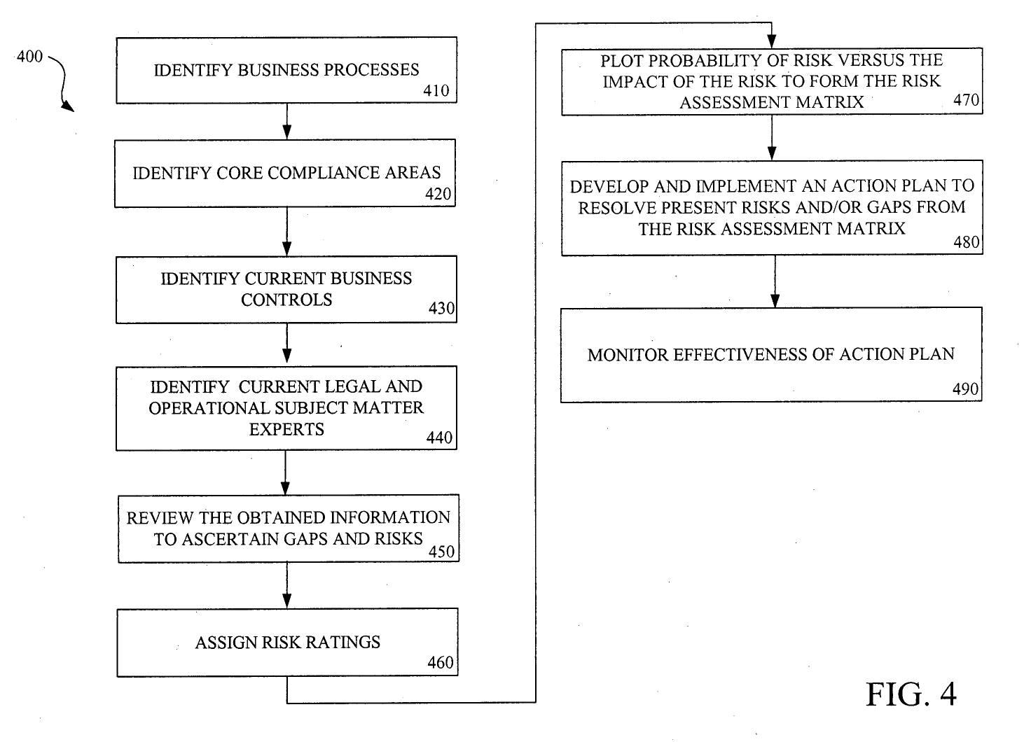

To determine business control levels for core compliance areas, the Business Controls group 270 (or a Business Controls group member or a respective business unit working in collaboration with the Business Controls group/member) follows a unified process 300, as shown in FIG. 4. First, this unified process includes identifying (410) associated business processes for a respective business unit. Further information is also identified (420-440), such as core compliance areas (applicable regulations, laws, and rules); current business controls (policies, procedures, training, audits); and the current legal and operational subject matter experts for the respective business unit. To aid in compiling the aforementioned information, an inventory template or form may be used. By reviewing the obtained information and conversing with the subject matter experts, the compliance gaps and risks are ascertained (450). For example, the risks may identify what can happen or go wrong with the current business processes, and the gaps may identify what compliance measure or practice should be happening that is not. The gaps and risks are then prioritized (e.g., from most likely to least likely, for example) and assigned (460) a risk rating. The risk rating (e.g., senior management intervention, significant operations review, etc.) describes the level of operational action that should be taken if a potential risk occurs. To determine the risk rating, the impact or consequences of a potential risk (financial, physical, human, or intangible) and the probability or likelihood that the risk will occur are taken into account. Therefore, a particular risk that is likely to occur and would have a significant impact receives a higher risk rating than another risk that is unlikely to occur and would have a significant impact. The probability of each risk is plotted (470) versus the impact of the risk to form the Risk Assessment Matrix for the respective business unit.

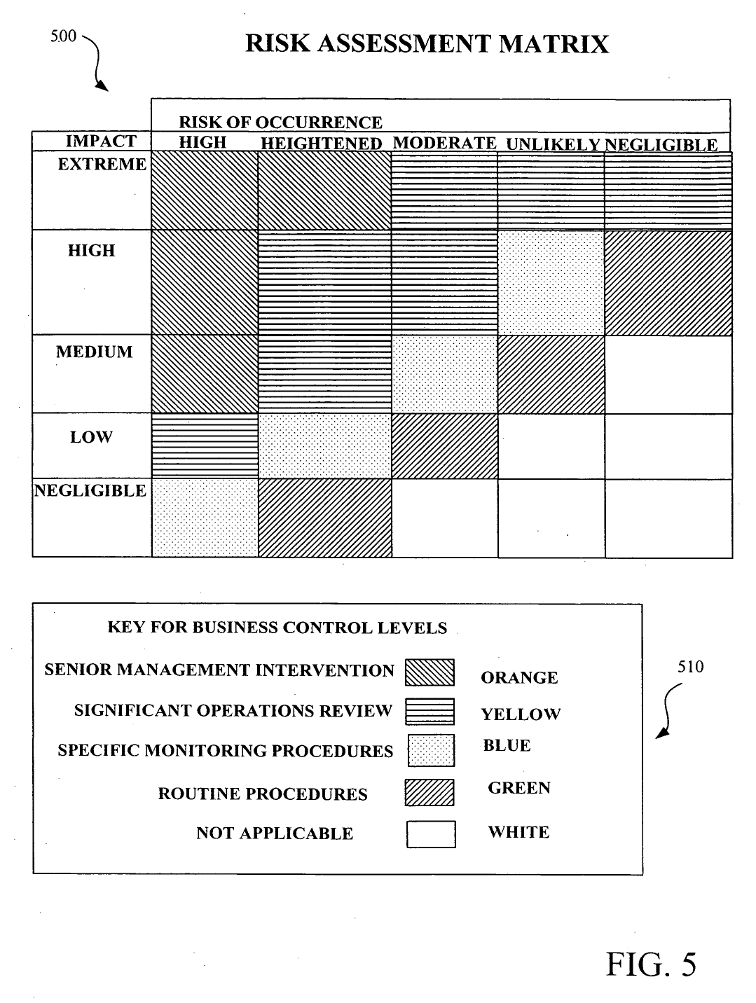

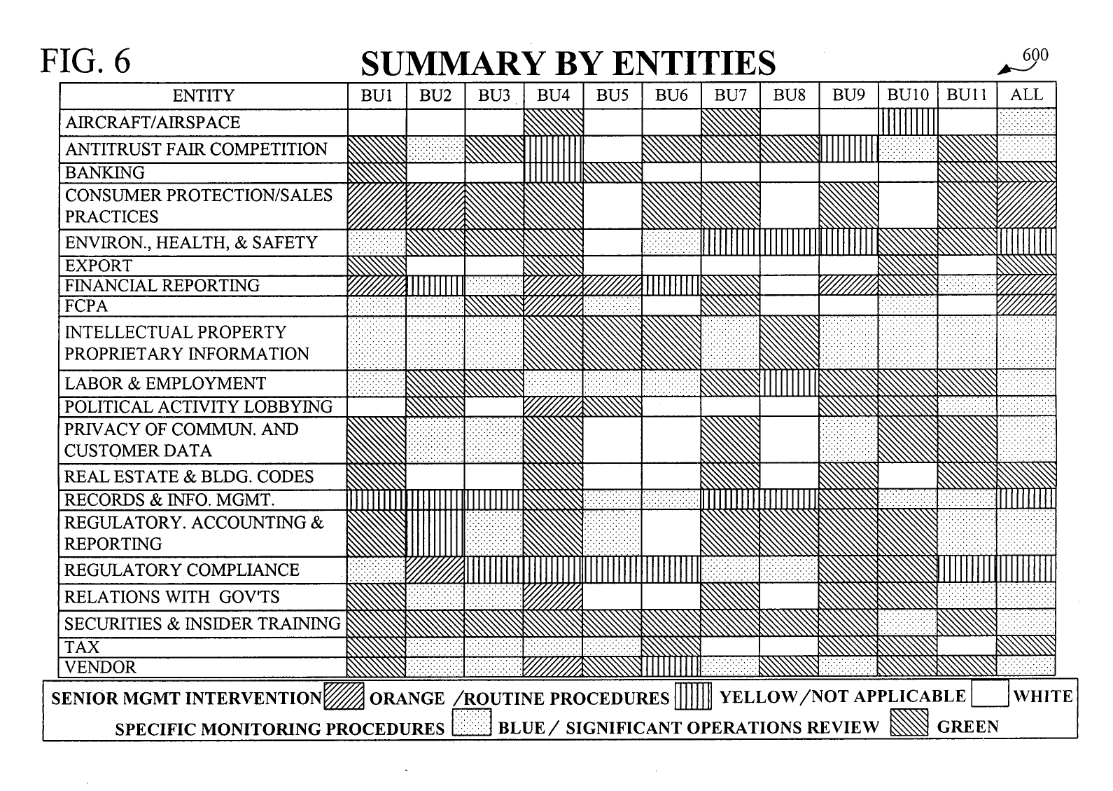

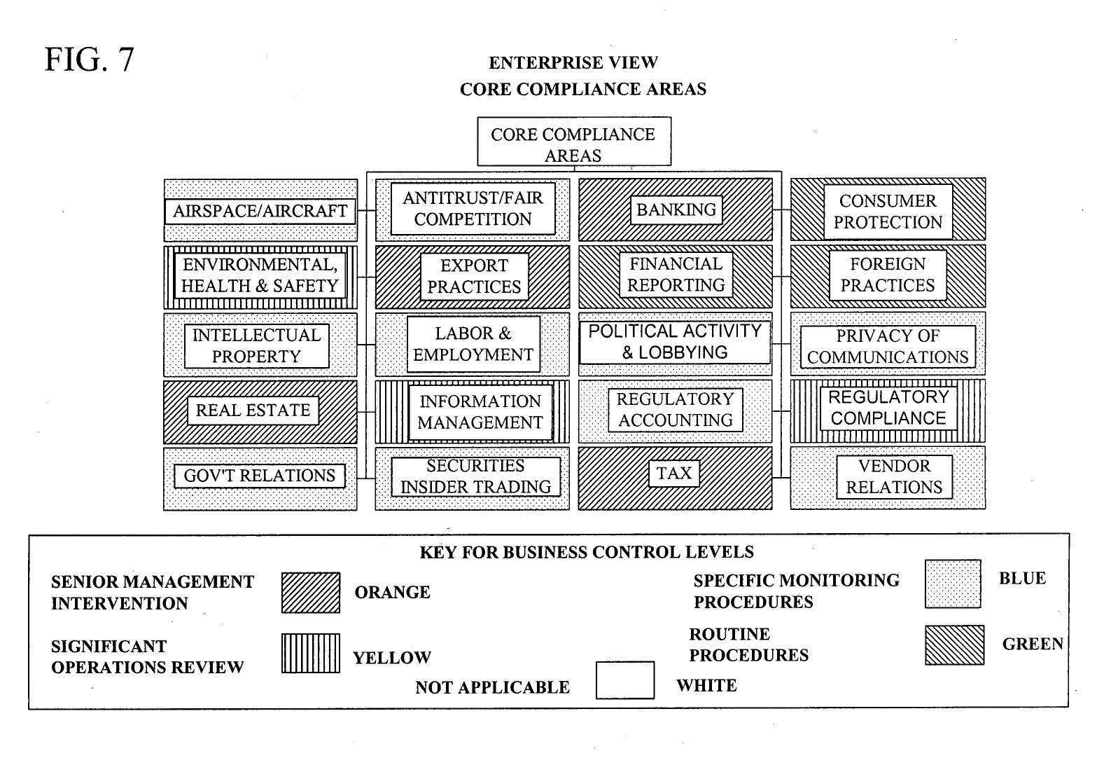

The Risk Assessment Matrix 500 helps evaluate impact over risk of occurrence in all core compliance areas for business units 291-297 as shown in FIG. 5. A color-coded assessment process 510 is used to easily and visually identify and understand the levels of risk. (Colors in FIG. 5 are represented by cross-hatched shading, as shown.) Accordingly, instead of showing that a risk is a “high risk” or a “low risk,” the Matrix 500 provides the level of business controls that should be used from an operational standpoint. Accordingly, if a risk has a potentially extreme impact on the business organization 202 (even if the proper business controls are already in place), the risk is assigned a “significant operations review” rating. The Risk Assessment Matrix 500 process provides the company with a quick snapshot of all risk areas for all business units 291-297. Typically, each business unit 291-297 completes this process for all core compliance areas. Accordingly, a summary 600 of risk assessment by business units may be constructed, as shown in FIG. 6, for the whole organization 202 (or enterprise). The summary 500 of risk assessment can then be used to form an organization-wide view of the planned business control levels for core compliance areas, as shown in FIG. 7. Note, if a particular business units does not have risks in certain areas, then the particular business unit does not analyze risks in these areas.

From the Risk Assessment Matrix 500, action plans are developed and implemented (480) by the Business Controls 270 group/member (in possible concert with the business units) to resolve the risks and/or gaps present in current business practices. Action plans may require policy changes, training, etc. Monitoring (490) of the effectiveness of the actions plans for the business units are performed at an organizational level (e.g., corporate level). For example, in some embodiments, the Compliance Group 230 continually monitors areas that need senior management intervention or significant operations review to ensure that adequate preventive, detective, and corrective business controls are in place and intervenes, when necessary, to drive proper action on gaps identified through risk assessment. A Subject Matter Expert in the appropriate Legal group 2.60 or operational business unit 291-297 is then responsible for validating these business controls and alerting personnel of emerging issues in a particular governance area. If the business controls are not deemed adequate by the Compliance Group 230 or Legal group 360, for example, the business unit 291-297 and the Compliance Group 260 work together to implement effective controls (regardless of whether the risk at issue is only present in one business unit out of a multitude). The inventory and risk assessment documents are normally reviewed yearly for the summarized Risk Matrix 500 and action plan by the business units 291-297. Further, when organizational changes occur and when changes in rules, laws, and/or regulations occur, these documents are reviewed by all the business units 291-297.

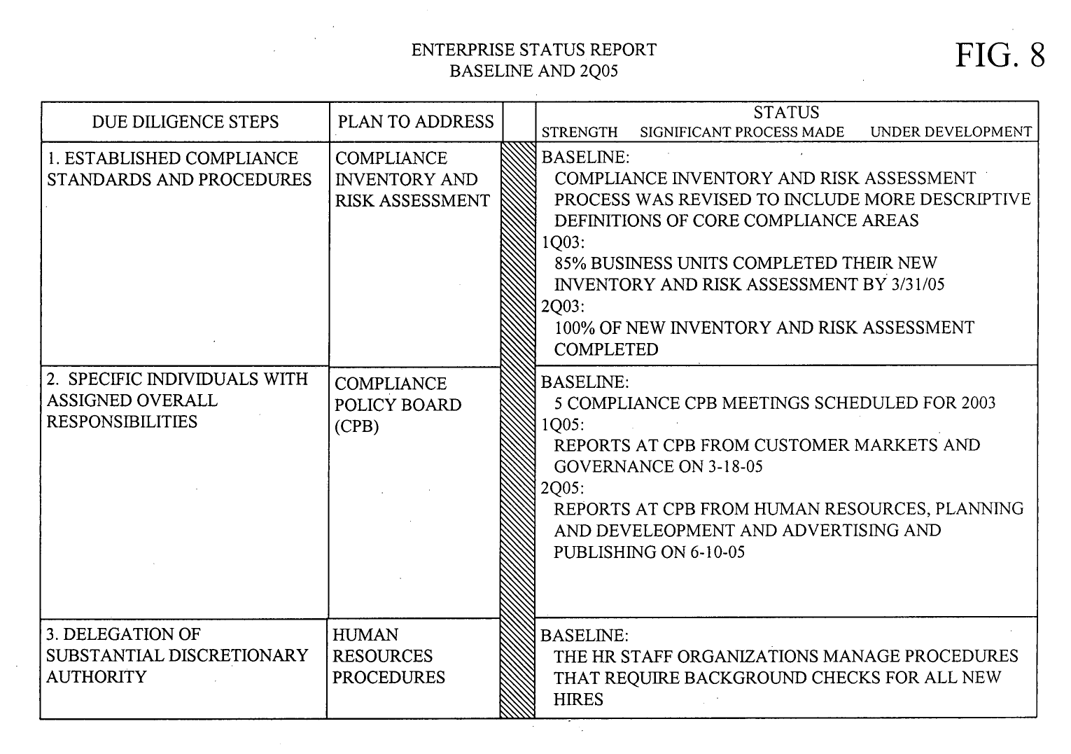

As shown in FIG. 8, the Compliance Group 230 tracks the status and progress of compliance activities (e.g., in a quarterly schedule). As a benchmark, progress may be tracked against the seven compliance areas addressed in the Federal Sentencing Guidelines. (The Federal Sentencing Guidelines for Organizations guidelines encourage organizations to develop “effective programs to prevent and detect violations of law,” and prescribe seven “types of steps” of an effective program which include (1) establishing compliance standards and procedures; (2) establishing compliance oversight; (3) exercising due diligence in delegating discretionary authority; (4) effectively communicating standards and procedures to employees; (5) utilizing auditing and monitoring systems to detect noncompliance; (6) implementing discipline policies to enforce standards and policies; and (7) taking reasonable steps to prevent compliance offenses from reoccurring.) Each group of activities is assessed in terms of their current effectiveness; the amount of significant progress that has been made in implementing the activity; and/or whether a compliance solution is under development. This provides a scorecard of organization-wide governance activities that is used to drive the continued evolution of governance activities, in some embodiments.

Within the Integrated Governance system 100, each Governance group 210-270, typically, has a separate database to accumulate information for their specific area of expertise. For example, in some embodiments, Ethics group 240 uses one database system 122, 140 to track telephone calls directed to an Ethics hotline (e.g., telephone number). Records in this database 122, therefore, contain the resolutions and dispositions of cases that were initiated by respective telephone calls to the Ethics hotline.

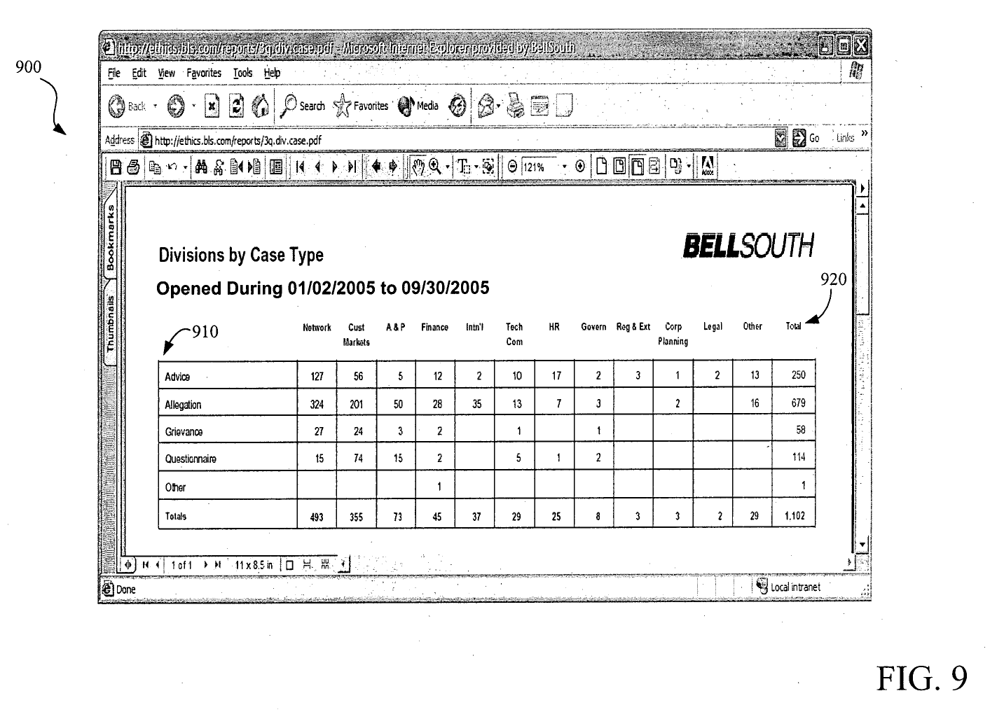

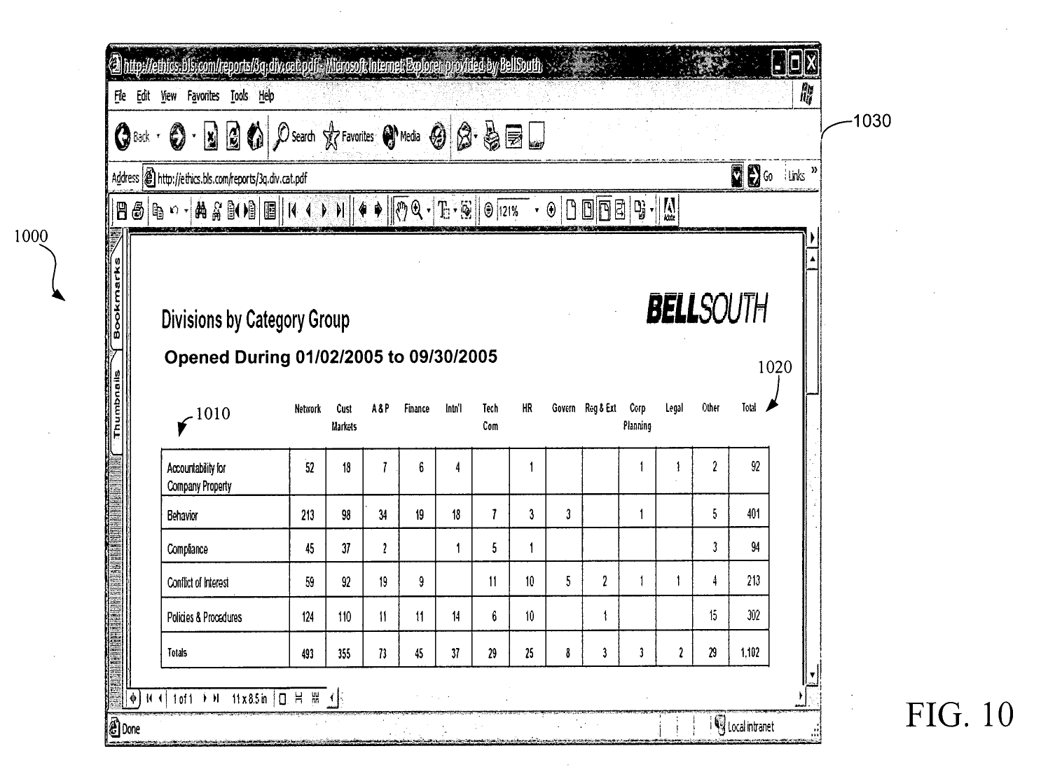

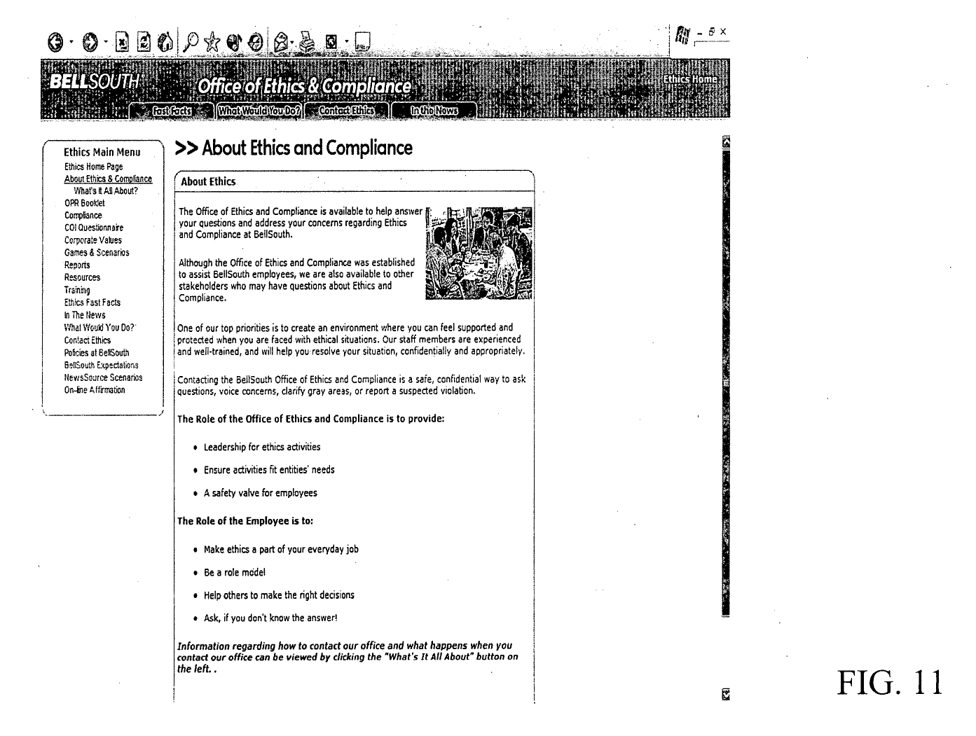

FIG. 9 is a sample ethics record 900 detailing the various types of Ethics 910 cases that have been opened during a particular period (Jan. 1, 2005 to Sep. 30, 2005) across the various business units 920. The sample record contains formatted information from database 122. In addition, FIG. 10 shows a sample ethics record 1000 detailing various categories of Ethics cases 1010 that have been opened during a particular period across various business units 1020. As illustrated by FIG. 10, reports from some of the governance databases may be accessed from database client applications that include a general Internet browser 1030 that is configured to display web pages compiled from data in the database 122. Further note, the Ethics and Compliance groups 240, 270 may also maintain an internal company website (that is compiled from data from group databases 122, 128 or some other database 129) to educate employees on company policies, ethics, personal responsibilities, etc., as shown in FIG. 11.

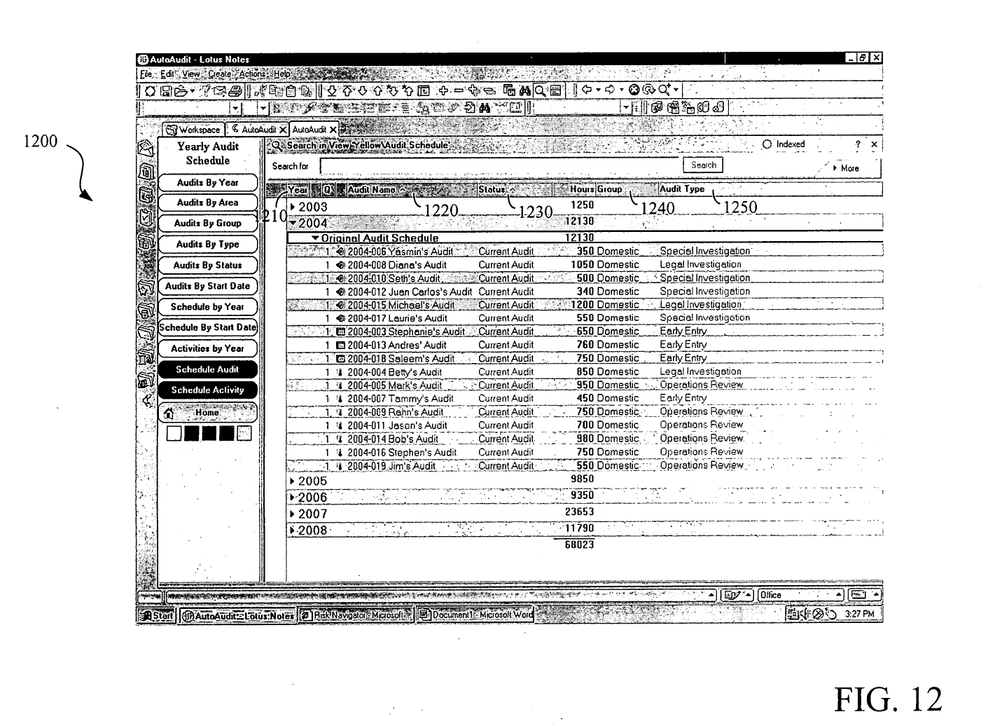

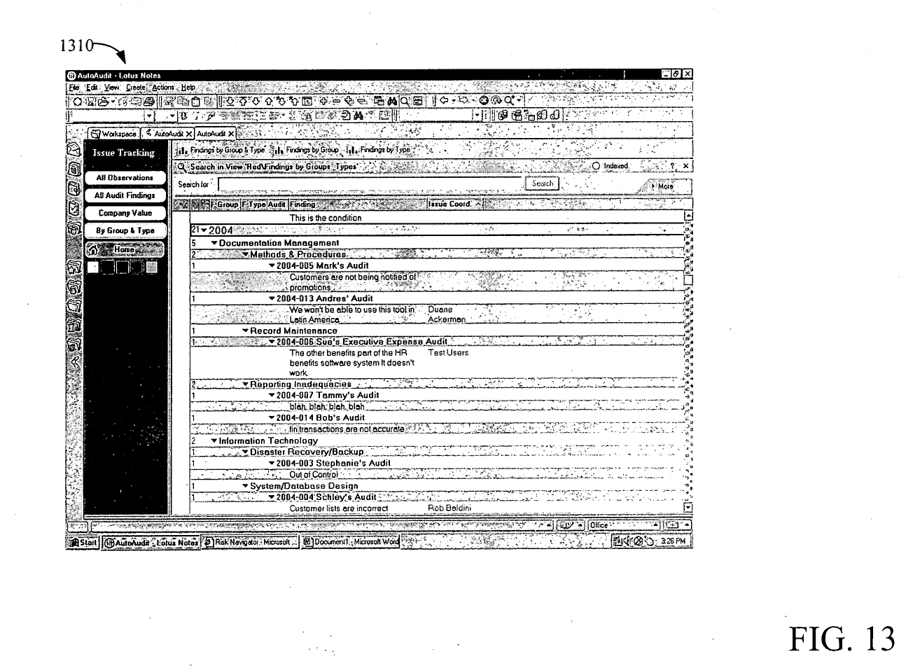

In some embodiments, the Internal Audit group 210 also uses a database 124 to store results from each audit the group performs and to track management responses. For example, FIG. 12 is a sample audit record 1200 that is included an audit database 124, in one embodiment. Record 1200 includes formatted information from database 124 and includes data entry fields used to setup up access to information regarding a particular Audit report. Record 1200 includes a year field 1210, an audit name field 1220, a status field 1230, a group field 1240, and an audit type field 1250. Additional fields are available and may be used to compile additional reports. For example, the report, shown in FIG. 13, displays audit findings that are sorted by the “type” of findings field. In this embodiment, the report is accessed from a Lotus Notes® data management program 1310.

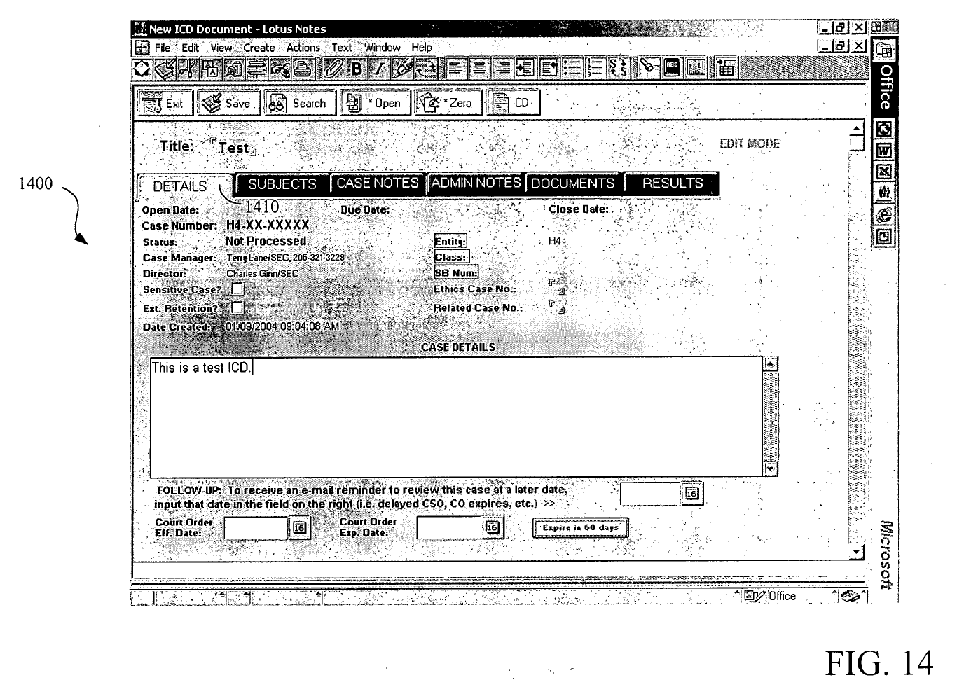

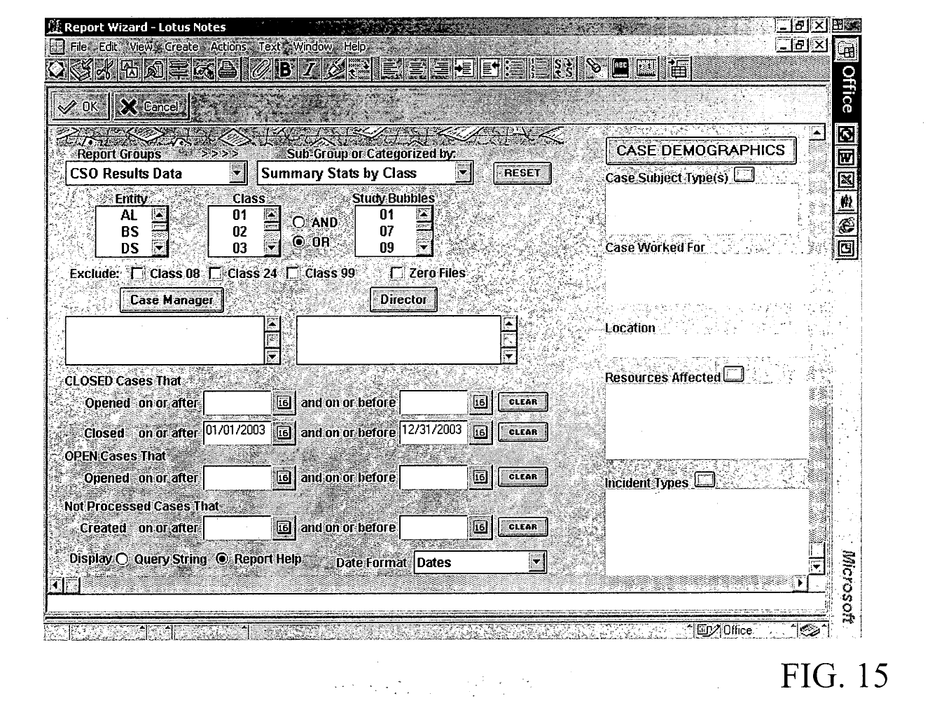

Security group 220 typically uses yet another database system 126, 144 to log in security investigations and their outcome. FIG. 14 is a sample security case management document 1400, as described above, that is included a Security database 126. Document 1400 includes formatted information from database 126 and includes data entry fields used to setup up access to information regarding a particular security report. Document 1400 is typically used by investigative managers to input details of an investigation; information about case subjects and witnesses; notes; copies of statements & reports; and information about the results of an investigation. As shown, mechanisms exist to either submit the entered information to database 126 or to cancel the submission of inputted data. A save button 1410 causes the information entered into the data entry fields to be uploaded to server 144 and stored in database 126. Reports that include formatted information from database 126 may be compiled by customizing a search of the Security database 126. For example, FIG. 15 is a sample security case management document (e.g., a Report Wizard) for customizing a search of the database 126. Searches may be performed using a variety of criteria such as case demographics (e.g., where an incident occurred, the incident type, the impacted resources, etc.).

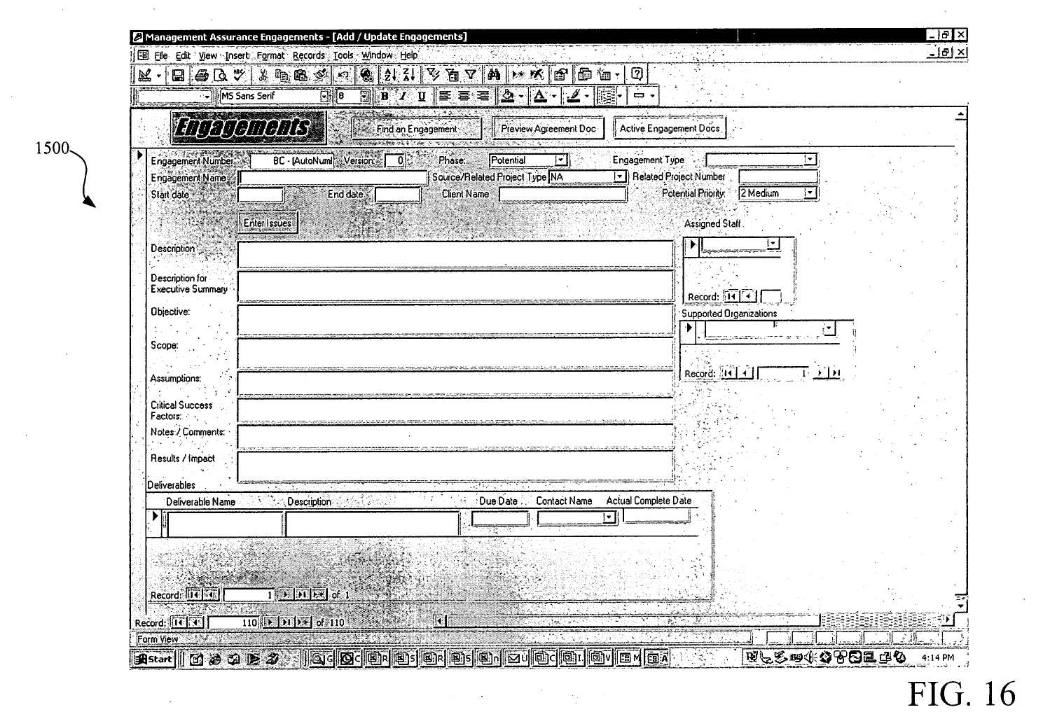

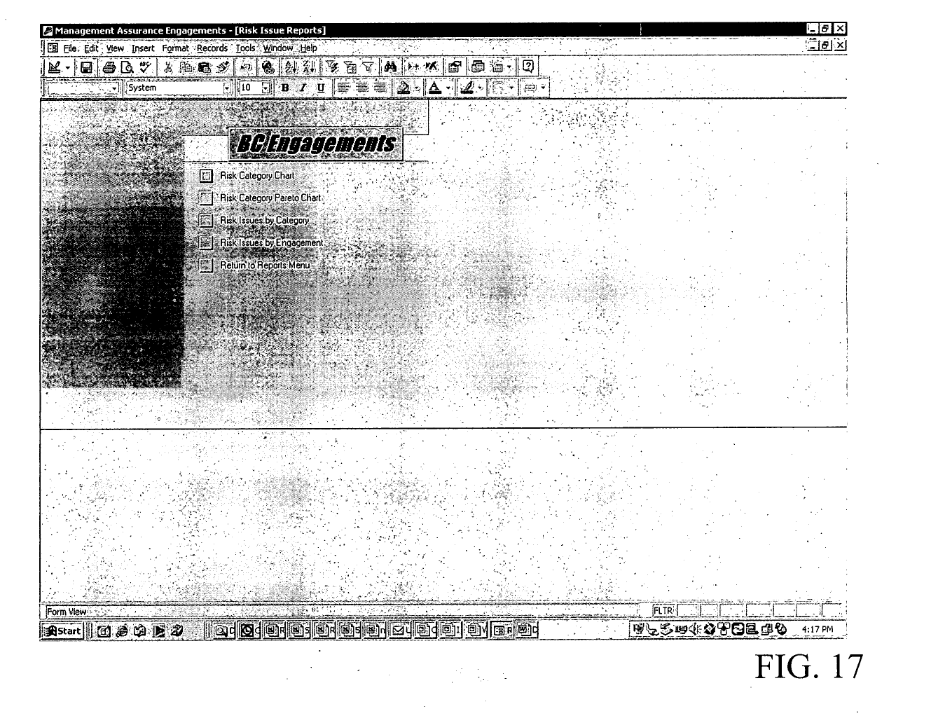

The Business Controls group 270, in some embodiments, also utilizes a database management program, such as in FIG. 16, to enter and track engagement consultations with a business unit. Thereafter, a data management program, as shown in FIG. 17, can generate various types of reports, such as those regarding risk issues.

With a multitude of governance databases 122-128 in the Integrated Governance system 100, operational business units 291-297 may find it difficult to obtain and grasp pertinent governance data regarding their respective business units 291-297. Consider that a large company or corporation may have the following governance data points over a six-month period:
58 Audit Engagements with 401 control points
347 Security Investigations
194 Ethicsline Allegations
85 Ethicsline Calls for Advice
14 Business Control issues
3700 People Trained on Compliance Initiatives

In order to leverage this type of data that is being accumulated by each of the governance groups, an Integrated Governance team 280 is provided, as shown in FIG. 2. Members of the Integrated Governance team 280 include leaders from the various governance groups 210-270 (e.g., Internal Audit group, Security group, Ethics group, Compliance group, Business Controls group, and Legal department). Compliance and audit coordinators from each business unit are also valuable members of the Integrated Governance team 280.

The Integrated Governance team 280 is formed to consolidate governance data from Internal Audit 210, Business Controls 270, Ethics 240, Compliance 230, and Security groups 220. In addition, the Integrated Governance team 280 identifies emerging trends across the company so that the emerging trends can be proactively addressed by all organizational departments. By pulling together data that pertains to all of the various business units, valued information is acquired about the company as a whole. Accordingly, the various databases and systems reveal the consistency of an issue across a broad breadth of transactions. Therefore, data regarding one business unit's activities can be used to improve the business activities of another business unit. As such, a particular business unit can learn from the experiences and knowledge gained from other business units.

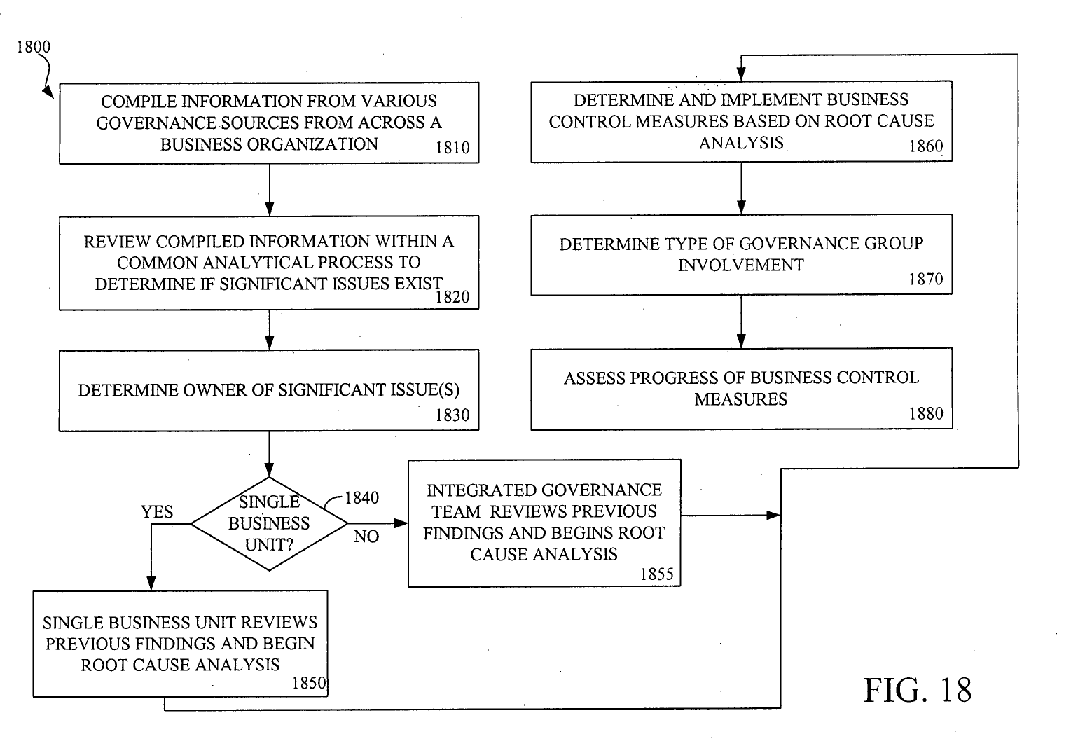

Some of the activities of the Integrated Governance team 280 are as follows. As a result of creating self-awareness regarding themes and issues within and across organizations (by reviewing governance data from across all business units), the Integrated Governance team 280 makes informed decisions as a leadership team 280, especially where policies, systems, or funding are impacted. For company wide organization-wide issues (e.g., affects more than one business unit) and issues with no clear owner (e.g., has not been assigned the responsibility of a business unit), the Integrated Governance team 280 takes ownership and drives these issues to resolution. For high-priority and high-risk items, the Integrated Governance team 280 assesses their progress and develops further governance plans and/or assistance as deemed necessary. As shown in FIG. 18, an Integrated Governance process has been developed to complete these activities.

As stated, FIG. 18 is a flowchart describing one embodiment 1800 of the Integrated Governance process. First, information from various governance sources from across the entirety of the corporation are selectively gathered and compiled (1810) together regarding issues of interest. For example, in order to review levels of compliance within a business organization 202, governance sources may include databases of governance groups or agencies and any other database that is likely to contain reports or allegations of company noncompliance. Next, under a common analytical process, the compiled information is reviewed (1820) (by Integrated Team members having experience in the issues of interest and the various business units) to determine if significant issues exist. Further, owner(s) of the identified issue(s) are determined (1830) from among the various business units 291-297.

If the significant issue is identified (1840) as being the responsibility of a single business unit, then the business unit is assigned the responsibility of determining measures for dealing with the issue. Typically, the audit and compliance coordinators of the business unit; member(s) of the Compliance Group 230; and/or member(s) of the Business Control group 270 meet to review the Integrated Governance team 280's finding and to begin (1850) root cause analysis of the significant issue. After the root cause analysis, business control measures are developed and implemented (1860) to attempt to eliminate the cause of the significant issue. Accordingly, audit and compliance coordinators pull status information of the new business control measures and agree (1870) on the level of involvement from appropriate governance groups with the business control unit. The status information is provided for monitoring of the new business control measures. For example, by assessing (1880) the progress of the business measures, the Compliance group 230 and Business Controls group 270 can determine if there is an issue that needs to be raised to the leadership of the business unit. A report of the progress of the issue is also reviewed at quarterly staff meeting of business unit officers.

If the significant issue is identified (1840) as being a new issue that has not been assigned the responsibility of a business unit or is an organization-wide issue that is occurring across several business units, the issue is resolved outside of the business units. Typically, the Integrated Governance team 280 takes ownership of the issue and begins (1855) root cause analysis to determine the proper measures for addressing the issue and the appropriate governance group involvement. After this determination, the business units are informed of the issue and its new business controls via the Compliance coordinators in the business units. The progress of the new business measures is tracked within each business unit to determine if issues need to be raised to a business unit's leadership. A report of the progress of the issue is also reviewed at quarterly staff meeting of business unit officers.

With regard to step 1810 of FIG. 18, each Integrated Governance team 280 member is responsible for summarizing the data from their respective organizational department (e.g, compliance group, securities group, etc.). For companies with many business units, more than one team 280 member from the same governance group may be responsible for summarizing the data for a portion of the business units. For example, if a company has twenty business units, four members of the Security group 220 may be members of the Integrated Governance team 280 and each member may review “securities-type” data for five different business units. In some embodiments, databases 129 (regarding customer complaints, litigation, case settlements, etc.) outside of governance areas may also be reviewed to uncover emerging trends.

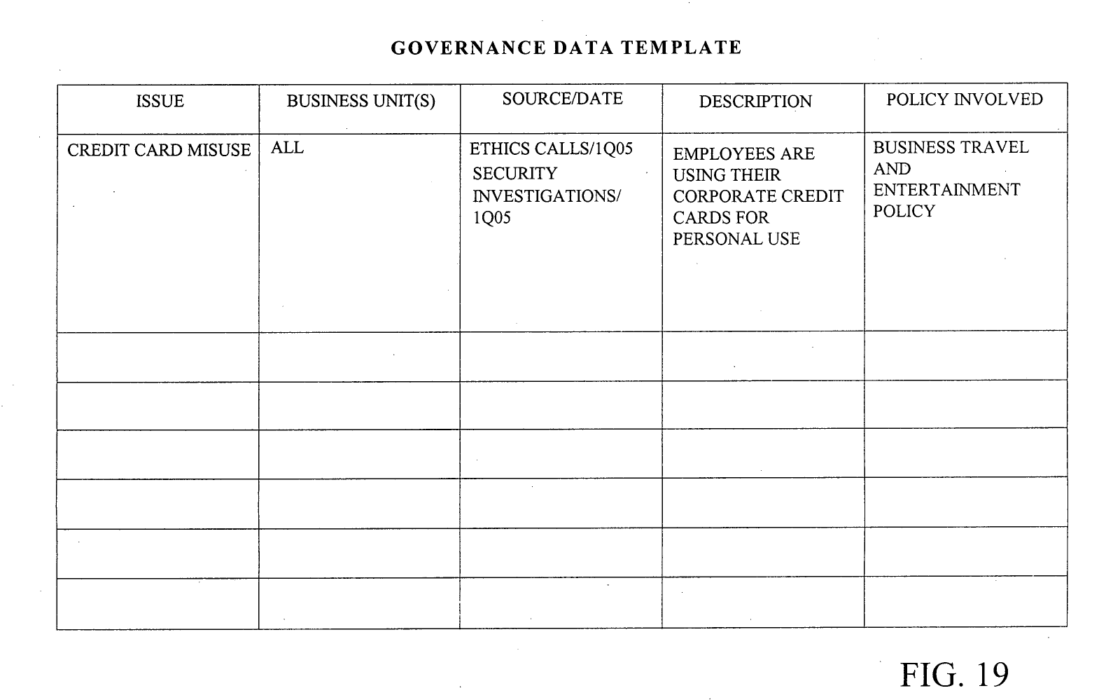

A common template or form document, as shown in FIG. 19, is used to accumulate issues regardless of which database was accessed. Typically, the Integrated Governance team member 280 records on the template the issue area that corresponds to one of the compliance core areas; the organizational department where the issue occurred; the governance source/date; and a description of the issue and the policy that is involved. For example, to aid in their analysis, Integrated Governance team 280 members may consider the following questions within their area of governance:
1. What types of data are trending upward (showing signs of increased problems)?
2. What are you heammg/seeing for the first time?
3. Where are the greatest risks?
4. What bothers you about what you're seeing/hearing?
5. What is the risk if this problem is not controlled or corrected?
   Since each governance database 122-128 is different, team members utilize their particular expertise and familiarity with the data contained in a particular database to recognize relevant data. For example, Integrated Governance team members 280 can utilize database applications 134 to perform keyword and Boolean searches to capture meaningful data from the databases 122-128. Preferably, in some embodiments, the records contained in the various databases are streamlined to contain similar fields and structure to simplify database searches. However, in some embodiments, it may not be cost-effective to modify pre-existing databases in a streamlined format. Therefore, the information is typically summarized by an Integrated Governance team member 280 who is familiar with the database and the type of information the database contains.

After all team 280 members complete their templates for all the governance areas, the data from each template is discussed within the Integrated Governance team 280 and re-organized (or prioritized) to reflect issues that are significant or that are occurring in multiple governance reports. These issues are then compiled as emerging issues. Emerging issues are either new to the business organization 202 or are being observed across more than one business unit. By considering all the issues that are occurring across the business units 291-297 of an organization at one time, the Integrated Governance team 280 can understand the root causes of these issues within a common analytical process (as mentioned in step 1820 of FIG. 18) that takes advantage of the collective knowledge of the members of the Integrated Governance team 280.

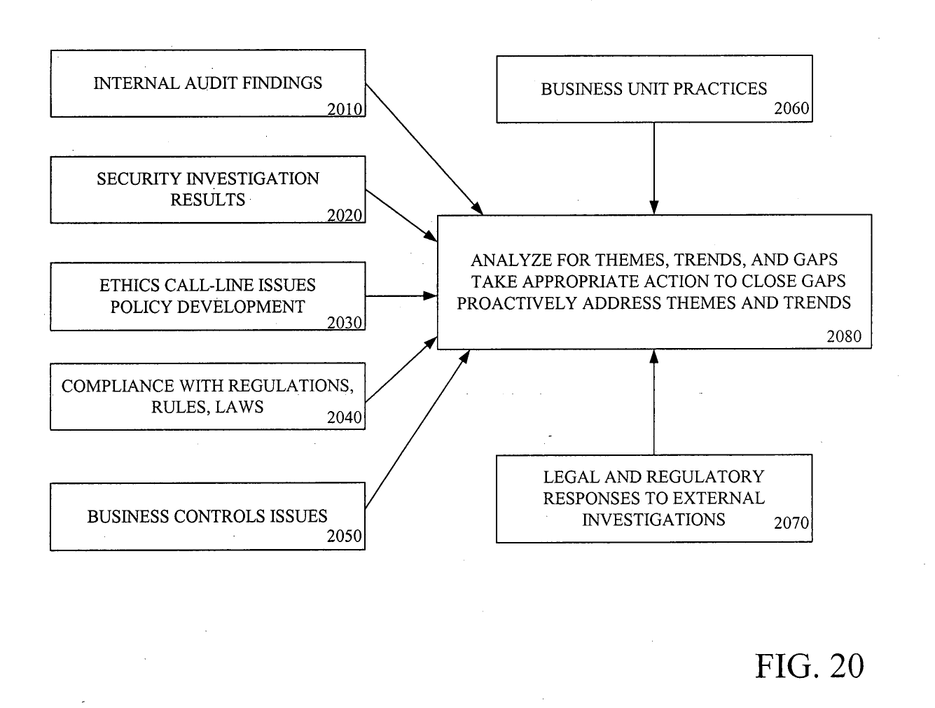

For example, FIG. 20 displays a flowchart depicting this common analytical process. As shown, governance reports (such as internal audit findings 2010, security investigation results 2020; ethics call line issues and policy development 2030; compliance reports 2040 regarding rules, regulations, and laws; reports on business controls issues 2050), business unit practices 2060, and legal reports 2070 from external investigations are collectively examined and analyzed (2080) for themes, trends, and gaps in core compliance areas. Accordingly, appropriate actions are taken to close existing gaps and to proactively address themes and trends.

Through the business organization's governance structure, the Integrated Governance team 280 can ensure that action is taken on a significant issue. For example, in multiple audit reports, the Integrated Governance team 280 may discover an issue that does not have a natural owner with respect to one of the governance groups or business units. Accordingly, the Integrated Governance team 280 takes ownership of the problem and determines a proper resolution for the issue (as previously discussed with regard to step 1850 of FIG. 18).

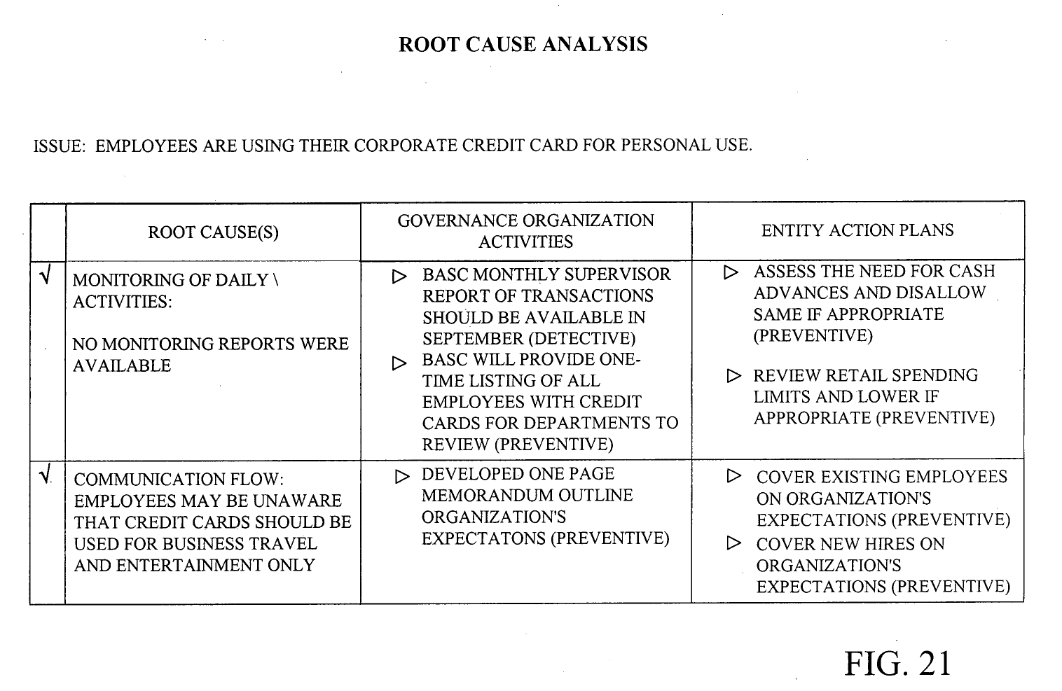

One technique, among others, for determining the root cause of emerging issues is the “5 Why” technique. Here, the Integrated Governance team 280 asks why a problem has occurred through five iterations to get at the root cause. Note, it is important to determine the root cause of issues so that the Integrated Governance team 280 can ascertain if the appropriate level of business controls has been enacted. For each root cause, all current business controls are documented, as shown in FIG. 21, for one example. Then, the team 280 ensures that appropriate preventive, detective, and corrective controls are in place. If there seems to be a gap, the team 280 identifies and documents this as well. Gaps may be escalated to business unit leadership for resolution (along with assistance from the Integrated Governance team 280). Typical issues that fall into this category revolve around issues that have been previously assigned to the responsibility of a particular business unit (“owner”). Note, uncovered issues do not necessarily have to be a compliance issue, but can be something that is unusual from a general business perspective.

Gaps often occur because no one business unit has been assigned responsibility for a process. In these cases, an owner (e.g., a particular business unit) is given accountability and appropriate business controls are then developed by or in concert with the owner. Further, other gaps may cross several operational business units with no clear owner. In these cases, as previously stated, the Integrated Governance team 280 takes ownership of the problem and drives a resolution for the problem. Once a solution is determined, responsible parties (e.g., compliance coordinators, senior leaders, etc.) within the business units are enlisted to make sure that solutions are implemented within the respective business units. In this way, the Integrated Governance team 280 is part of the solution in finding remedies to existing problems. Moreover, with the assistance of the Integrated Governance team 280, a solution is reached that is applicable to the business organization as a whole (and is known to comply and work), rather than disparate ad-hoc fixes implemented by different business units.

Typically, emerging issues are summarized in a report format by the Integrated Governance team 280 and circulated to the business units quarterly (via compliance coordinators). Compliance and Business Controls groups also typically make an oral presentation quarterly to key business leaders to acquaint them with the issues and the plans for resolution. These discussions are two-way, and often result in productive dialogue about additional ways that governance groups can add value to the business units.

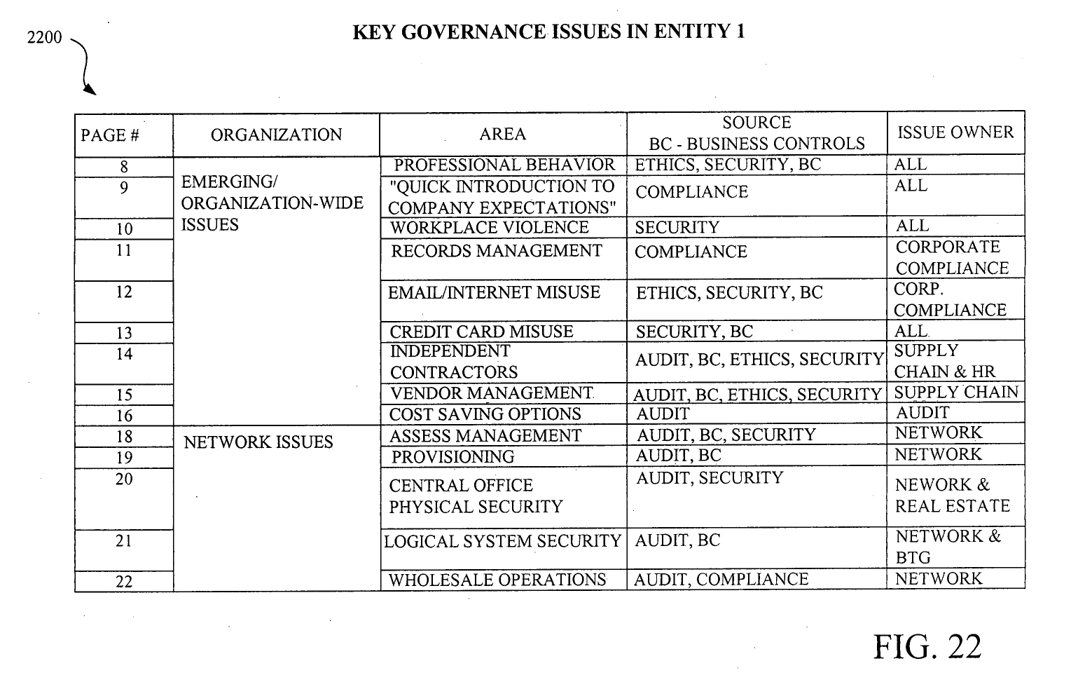

Additionally, the Integrated Governance team 280 tracks all outstanding issues to ensure that adequate progress is being made. After it is determined that the gaps have been closed, the respective issue is closed and removed from the quarterly tracking report. FIG. 22 shows a sample quarterly tracking report 2200 detailing outstanding issues that are being monitored by the Integrated Governance team 280 in this particular example (for business unit or entity #1). After the Integrated Governance team 280 determines that all the gaps have been closed in a compliance area or issue, the issue is removed from the quarterly tracking report 1300.

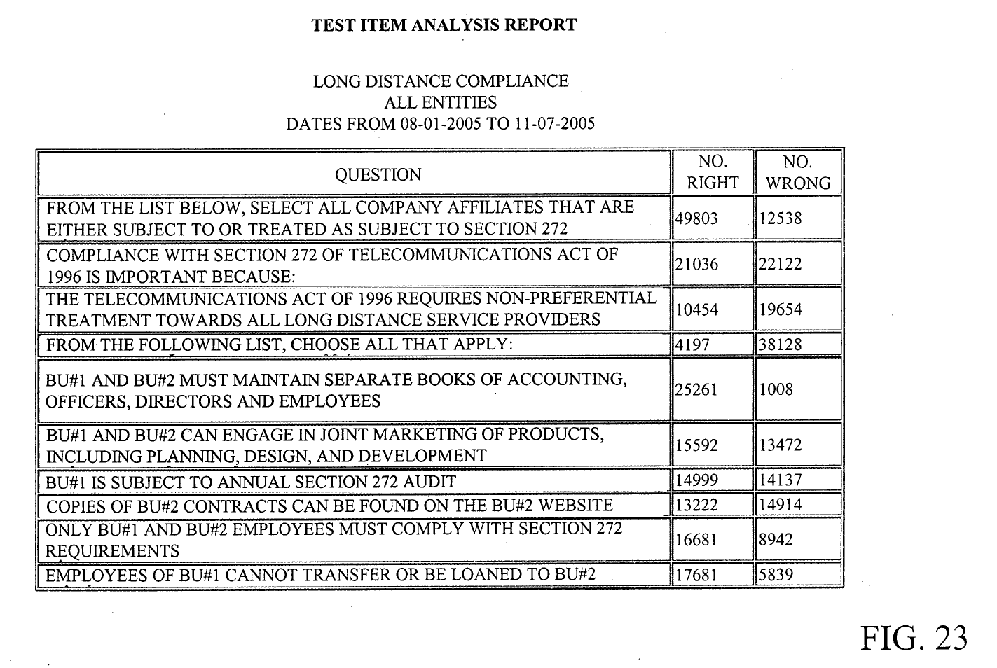

Consider that training is one method for resolving compliance gaps. For example, a new training program may be implemented to help resolve a business issue by educating persons within the organization about the issue. Then, by employing subsequent mastery tests, the Integrated Governance team 280 is able to examine the results of the mastery tests (e.g., commonly missed answers) to determine if persons within the organization understood the training, the underlying policy, the concept being taught, etc. For instance, FIG. 23 shows a sample report of the results from an example training exercise regarding compliance practices regarding long distance telephone rules and regulations (for all business units or entities).

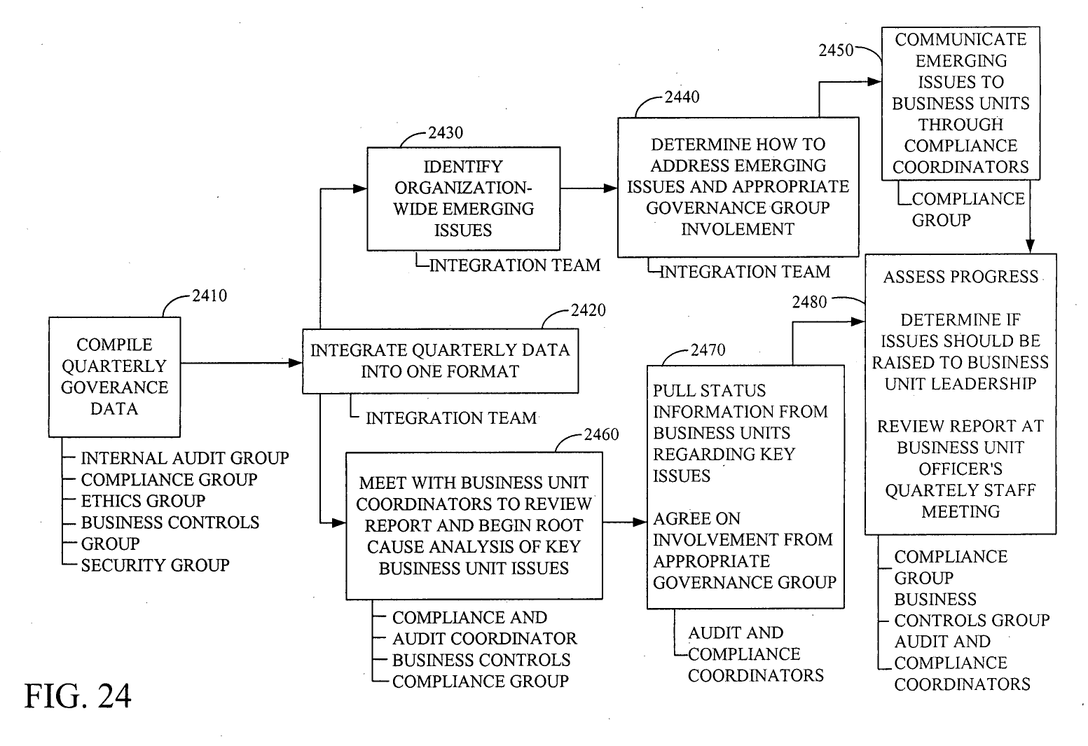

Next, FIG. 24 is a flowchart describing the Integrated Governance process 1800, for one embodiment, in terms of performed activities and owners of these activities (as has been previously mentioned). As shown, in this embodiment, the Internal Audit group 210, the Compliance group 230, the Ethics group 240, the Business controls group 270, and the Security group 220 are in charge of compiling (2410) quarterly governance data from respective databases according to their subject areas. Then, the compiled data is presented to the Integrated Governance team 280 to be reviewed and integrated (2420) into one common format. Here, the Integrated Governance team 280 identifies (2430) organization-wide emerging issues and sole business unit issues.

The organization-wide business issues are handled by the Integrated Governance team 280 which determines (2440) how to address the emerging issues and the appropriate governance group involvement. Afterwards, the compliance group is informed of the emerging issues from the Integrated Governance team 280. Through compliance coordinators, the individual business units are informed (2450) of the emerging issues and associated plan of action for handling the issue.

Sole business issues are given to the business units (e.g., via audit and compliance coordinators of the business units) who work with the Compliance group 230 and the Business Controls group 270 to review the findings of the Integrated Governance team 280 and begin root cause analysis (2460) of the business unit issue(s) (as previously discussed). The business unit coordinators and governance groups work together to determine how to address the business unit issue and to determine (2470) the appropriate type of governance group involvement. Via the business unit coordinators, the business units are informed of new business control measures.

The Compliance group 230, the Business Control groups 270, and the compliance coordinators in respective business units monitor and assess (2480) the progress of implemented business control measures to determine if the issues should be presented to business unit leadership. Also, the progress of implemented business measures is reviewed at quarterly staff meetings.

The following is an example of the Integrated Governance process 1800 in action, for one embodiment. First, an Ethics group 240 receives a telephone call (e.g., from “Ethics Hotline” or “Ethicsline”) regarding employees abusing company credit cards by charging personal expenses on them. This is in direct violation of company policies. The Security governance group 220 investigates these allegations and finds that that the telephone reports are valid. While in an Integrated Governance team 280 meeting, both the Security and Ethics team 280 members raise this as an emerging issue. Using the “5 Why” Technique, the Integrated Governance team 280 probes to understand the root causes of this problem:
1. Question: Why did employees use company credit cards for personal purchases?
   Answer: Many of these employees did not know that it was against company policy.
2. Question: Why weren't employees familiar with our policy?
   Answer: Many of our employees were new and they had never been told by their supervisors about this policy.
3. Question: Why aren't supervisors covering their new employees?
   Answer: Many of them are too busy. Also, most of our employee base has typically had long tenure.
4. Question: Why is this problem just surfacing from new employees?
   Answer: We recently hired many new employees—in fact, in one organization, 52% of their current employee base has less than one year of experience.
5. Question: Why did this problem surface through Ethics and Security and not through the supervisors?
   Answer: Because there were no mechanized reports for supervisors to spot violations of the policy.

Accordingly, in this example, the root cause discussion leads the Integrated Governance team 280 to several conclusions and recommendations:
Employees, especially new ones, needed a quick way to understand the company's expectations about credit card use. A clearly written one page memorandum outlining these expectations is then developed by the Integrated Governance team 280 and circulated to all company departments. Also, awareness is enhanced through employee newsletters and office television monitors. (Preventive Control).
New employee orientation is changed to include the coverage of the company's expectations about all policies and procedures. (Preventive Control).
Since the lack of reports is a company-wide problem, the Integrated Governance team 280 works with other departments to develop mechanized reports that are provided to all business units.
One-time reports are provided that show all employees with a company credit card and the associated credit limit. (Detective Control). Supervisors are then asked to verify that the employee should have a card, and that the credit limit is appropriate. (Corrective Control).
Monthly reports are provided to supervisors to show all purchases made by employees. These reports can quickly be scanned for unusual purchases. (Detective Control).

Hence, one end result of the Integrated Governance process 1800 is that the Integrated Governance team 280 helps the operation business units 291-297 understand a problem that was emerging across the company. In this example, the Integrated Governance team 280 identified the problem, analyzed the root cause, and then worked to develop and implement an appropriate solution. This saved time for the business units 291-297 and ultimately reduced fraud and the potential firing of high-performance employees.

Although documented processes may have been in place for some time across individual governance functions, the Integrated Governance process 1800 ties information from these functions together to better understand business problems and areas of risk. Thus, the Integrated Governance process 1800 evolves corporate governance, for example, from a program of form to one of substance. By determining root causes of problems and not just symptomatic indications, the Integrated Governance process 1800 helps guarantee that solutions are meaningful; appropriate; and actually fix fundamental issues.

With the Integrated Governance approach, governance issues are examined across governance functions (Security, Compliance, Ethics, Internal Audit, Business Controls, Legal, etc.) by, consolidating data across these governance functions, for example. Because the Integrated Governance team 280 is exposed to data across governance, their knowledge about other areas of the business is increased and improved. Further, emerging trends and patterns are identified from the consolidated data and root causes of issues are determined. Plus, the potential risk of problems are evaluated and current control processes are examined to determine if the current controls are adequate. The Integrated Governance team 280 assumes ownership of problems that do not have a clear owner and develops solutions to the problems for the business units. In this way, the Integrated Governance process positions the governance groups as a problem solver as well as a problem-identifier. Accordingly, the Integrated Governance team 280 tracks progress of an issue until the issue has appropriate preventive, detective, and corrective business controls in place.

By leveraging a stable and strong compliance program, the function of the compliance program evolves into something more meaningful to the operational side of a business organization 202. Further, the operational business units 291-297 are active participants in all steps of the Integrated Governance process. Via the Integrated Governance process, the Integrated Governance team 280 assists operational business units in more than just compliance issues. For example, the Integrated Governance team 280 can provide guidance to business units on what to do from a compliant stand point and a governance standpoint (auditing, securities, what has highest priority, highest risk, etc.).

The Integrated Governance team 280 can also help business units understand the meaning of various governance data (e.g., security investigations, ethics reports, internal audits, etc.) and provide comprehensive feedback on what the business units have done and should do in the future. As a result, a sole compliance officer does not have to carry the sole responsibility of understanding and applying risk of exposure to compliance areas and to assess risk of exposure to ensure that a compliance program is in place.

Rather, the Integrated Governance team 280 is a formal compliance program that documents the existence of and the addressing of business risks. Moreover, by focusing on preventing problems rather than waiting on Internal Audit or other sources to document issues, the Integrated Governance process 1800 advantageously spots trends and patterns and “one-off” issues that may have arisen sporadically in various departments through various mechanisms.

It should be emphasized that in some alternative implementations, the functions noted in the blocks in flowcharts may occur out of the order noted in the flowcharts. For example, two blocks shown in succession may in fact be executed substantially concurrently or the blocks may sometimes be executed in the reverse order, depending upon the functionality involved, as would be understood by those reasonably skilled in the art of the present disclosure.

It should also be noted that the above-described embodiments of the present disclosure, particularly, any “preferred” embodiments, are merely possible examples of implementations, merely set forth for a clear understanding of the principles of the disclosure. Many variations and modifications may be made to the above-described embodiments without departing substantially from the spirit and principles of the disclosure. All such modifications and variations are intended to be included herein within the scope of this disclosure and protected by the following claims.

1. A system for providing an Integrated Governance program, comprising:
a plurality of governance sources monitoring respective governance areas within a business enterprise;
a plurality of governance databases, each database maintained by a respective governance source;
at least one or more communication networks interconnecting the plurality of governance databases; and
an integrated governance team reviewing data within the plurality of governance databases to identify significant issues for the enterprise in the governance areas.

2. The system of claim 1, wherein the integrated governance team further determines a plan, at an enterprise level, to address the significant issue across the enterprise.

3. The system of claim 1, further comprising:
a database of the integrated governance team for storing a summary of governance information from the plurality of governance databases.

4. The system of claim 1, wherein the plurality of governance sources include at least one from the group of an audit department, a security department, an ethics department, a business controls department, and a compliance department.

5. An Integrated Governance method, comprising the steps of:
individually summarizing data from a plurality of governance databases located on a business network of a business enterprise;
reviewing the data at an enterprise level to identify one or more significant issues to the business enterprise;
determining a plan, at the enterprise level, to address the significant issue across the business enterprise; and
communicating the plan to each operational unit within the business enterprise.

6. The method of claim 5, wherein the plan involves developing business controls for addressing the significant issue.

7. The method of claim 5, further comprising the step of:
implementing the plan within each operational unit of the business enterprise.

8. The method of claim 7, further comprising the step of:
tracking the progress of the plan in addressing the significant issue within each operational unit.

9. The method of claim 5, further comprising the step of:
analyzing, at the enterprise level, each significant issue to ascertain a respective cause of the significant issue.

10. The method of claim 5, wherein the plurality of governance databases are maintained by a plurality of governance departments, the governance departments including at least one from the group of an audit department, a security department, an ethics department, a business controls department, and a compliance department.

11. The method of claim 5, the individually summarizing step comprising:
electronically accessing each governance database containing governance data for operational units of the enterprise; and
utilizing a person familiar with a particular governance database to complete a template summarizing the governance data contained in the particular governance database for the operational units.

12. The method of claim 11, wherein the template includes areas for providing details concerning the significant issue and the operational units affected by the significant issue.

13. The method of claim 5, wherein the method is performed at periodic intervals.

14. The method of claim 5, wherein significant issues include issues that are new and issues that occur across multiple operational units.

15. The method of claim 5, the reviewing step comprising:
utilizing collective knowledge within the business enterprise to identify the one or more significant issues.

16. The method of claim 15, wherein the collective knowledge within the business enterprise includes an understanding of current business practices of the operational units.

17. The method of claim 15, wherein the collective knowledge within the business enterprise includes an understanding of recent legal matters concerning the enterprise.

18. The method of claim 5, further comprising the step of:
reviewing the data at the enterprise level to identify one or more issues that occur within a domain of a single operational unit;
determining a strategy, at the single operational unit level, to address the one or more issues that occur within the domain of the single operational unit;
communicating the strategy to each operational unit within the enterprise; and
monitoring the progress of the strategy, at an enterprise level.

19. A method for implementing an integrated governance program, comprising the steps of:
forming an integrated governance team to identify problematic issues in designated governance areas across a business enterprise, the integrated governance team comprising members having knowledge of each of the designated governance areas and of operational units within the enterprise;
compiling data from a plurality of databases that contain information regarding the governance areas for a plurality of the operational units in the enterprise;
integrating together data from the plurality of databases to form a comprehensive summary of governance information for the enterprise;
analyzing, as a team, the comprehensive summary to identify one or more significant issues within the governance areas for the enterprise;
utilizing collective knowledge of the integrated governance team to uncover the fundamental cause of the respective significant issue; and
forming, as a team, a comprehensive plan to address the fundamental cause of the respective significant issue across the enterprise.

20. The method of claim 19, wherein the compiling step is performed by particular members familiar with the information contained in the databases.

21. The method of claim 19, further comprising the step of:
communicating the plan to each of the operational units in the enterprise.

22. The method of claim 19, wherein the comprehensive plan involves developing business controls for addressing the respective significant issue
